(19) United States
(12) Patent Application Publication
(10) Pub. No.: US 2013/0320250 A1
(43) Pub. Date: Dec. 5, 2013

(54) ELECTRONIC FLOW CONTROL METHOD FOR A SPRING DIAPHRAGM IRRIGATION CONTROL VALVE USING A PULSED SIGNAL

(71) Applicants: Daniel GRAHAM, Riverside, CA (US); Geza KISCH, Riverside, CA (US); Thomas CARR, CORONA, CA (US)

(72) Inventors: Daniel GRAHAM, Riverside, CA (US); Geza KISCH, Riverside, CA (US); Thomas CARR, CORONA, CA (US)

(21) Appl. No.: 13/482,102

(22) Filed: May 29, 2012

(51) Int. Cl. F16K 31/06

(52) U.S. Cl. 251/129.04; 251/129.15; 251/129.05

(57) ABSTRACT

Improvements in an electronic valve control system is disclosed where the valve is a spring diaphragm irrigation control valve where the flow rate is controlled with pulsed signal to a control solenoid. This device functions as hydraulic amplifier where the input signal is characterized by the duty cycle ratio of the applied electrical signal, and the output is the flow rate through the irrigation valve. The pilot path of the solenoid on the valve is rapidly alternated between enabled and disable states. This is achieved by installing an electrically actuated valve at some point along pilot path. The electrical signal to this valve is rapidly pulsed. This causes the irrigation valve to be held in a partially opened state. The duty cycle of the pulse signal controls the flow rate of water through the irrigation valve.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to providing a means for electrically controlling the flow rate of a spring diaphragm irrigation control valve. More particularly, a pulsed signal is used to control the flow through the pilot tube paths, thereby providing electrical flow control of the irrigation control valve.

2. Description of Related Art Including Information Disclosed under 37 CFR 1.97 and 1.98

Irrigation control valves are commonly used in irrigation systems to turn the flow of water on and off. Irrigated landscapes typically contain a mix of turf and shrub areas which are irrigated by sprinklers. All the major manufactures of irrigation control valves for this type of irrigation use a spring diaphragm type of valve. This type of control valve is normally opened by activating a solenoid valve with a 24 Volt 60 Hertz electrical signal. Sometimes they are activated by 110V or DC Voltage This signal is produced by a controller which is generally connected to the valve with electrical wires.

A critical factor in the operation of irrigation systems is the regulation of pressure. For an irrigation system to function efficiently, the pressure at each control valve must be close to the pressure specified by the irrigation system design. The tolerance range is typically ±5 PSI.

Whereas the irrigation control valve is opened and closed with electrical control, the flow through the irrigation valve is adjusted manually to produce the required operating pressure. In practice, it is operationally difficult to ensure that each control valve will produce the correct pressure. It is a tedious and time consuming task for irrigation technicians to measure the pressure at each control valve and adjust its flow control setting to produce the required pressure. This is seldom done properly in the field. For this reason, the operational pressure at the control valves often differs from the irrigation design specification. This leads to reduction in irrigation efficiency. Often this also results in damage to sprinkler heads and lateral lines

Another important consideration for the operation of irrigation control valves is the rate of opening and closing the valves. Opening or closing a valve too fast can cause water hammering and cavitation of the pipes. These effects often cause damage to the irrigation system that is expensive to repair. Although irrigation valves are typically constructed to open and close slowly, the actual open and close rates necessary to avoid water hammering and cavitation depends on the hydraulics of each irrigation system. For this reason, water hammering and cavitation caused by the excessively rapid opening and closing of irrigation valves is common problem in the operation of irrigation systems.

There are many different methods of designing and constructing a spring diaphragm irrigation control valve so that the flow can be adjusted by manual mechanical means. However, there is no prior art for electronically controlling the flow. For all currently available spring diaphragm irrigation control valves, the solenoid is operated in either an open or closed position, the only control of flow is by manual adjustment, and the opening and closing rates are not adjustable. There are mechanically operated self-pressure regulating valves, but they generally do not work very smoothly, and the pressure oscillates by several pounds causing damage to pipes and irrigation components.

What is needed is an irrigation control valve that provides a simple and easy method for the irrigation system controller or other electronic device to set the pressure at each control valve, and for the irrigation system controller to also control the rate at which the valves open and closes. This would require that manual flow control be replaced with electrical flow control. This approach would lead to an efficient method of ensuring that each irrigation control valve is operated at the correct pressure, i.e. the pressure specified by the irrigation system design.

A number of patents and or publications have been made to address these issues. Exemplary examples of patents and or publication that try to address this/these problem(s) are identified and discussed. None of these approach this issue by means of electronic pulsing of the solenoid to control flow, or by any electronic means of controlling the flow or opening and closing rates of the valve.

To avoid water hammering and cavitation it would also be desirable to be able to control the rates opening and closing the irrigations control valves by electronic control. This would provide a means of adapting the open and close rates for each irrigation control valve based the hydraulics of its use within the irrigation system. In general, the time management of the irrigation system would be more efficient if the open and close times were increased only selectively where necessary to avoid water hammering and/or cavitation problems.

What is needed is a means of control over a valve or a master valve where the on and off time for the valve is electronically regulated to maintain a desired pressure. The control circuit and method disclosed in this application provides the solution.

### BRIEF SUMMARY OF THE INVENTION

It is an object of the electronic valve control system to embody ways of using a pulsed signal to control the flow through a spring diaphragm irrigation control valve with two main objectives. First, the rate of opening and closing the valve is electronically controllable. Second, the flow rate is electronically controllable. This provides the irrigation system controller with a means of electronically controlling the operation of each individual control valve.

The electronic valve control system is a modification of the standard spring diaphragm irrigation control valve. In the standard device, the irrigation valve is open when the flow through the pilot path is enabled. The irrigation valve is closed when the flow through the pilot tube path is disabled.

One of the novelties of the operational innovation of the invention is that the pilot path is rapidly alternated between enabled and disable states. One method of achieving this is by installing an electrically actuated valve at some point along pilot path or using the existing one. The electrical signal to this valve is rapidly pulsed. This causes the irrigation valve to be held in a partially opened state. The duty cycle of the pulse signal controls the flow rate of water through the irrigation valve.

A good choice for the electrically actuated valve is a solenoid valve. This type is commonly used for the spring diaphragm values used in the irrigation industry. However, the pulsation method can used any type of valve that is functionally equivalent to a solenoid valve. That is, it is opened or closed by the application of an electrical signal.

The electronic valve control system only requires that some electronic device deliver a pulsed signal to the electrically actuated valve. The simplest device meeting this requirement is a conventional signal generator that can produce pulse waveforms. For the practical use of our invention, the irrigation system controller should be modified to produce a pulsed signal. This modification is not part of our invention since it can be operated by any device capable of producing a pulsed signal with a variable duty cycle.

The application of the pulsed signal provides a means of electronically adjusting the average flow through the pilot tubes. In general, a spring diaphragm irrigation control valve will have at least two pilot tube paths. These connect the control chamber to the supply and load sides. An electrically actuated valve can be inserted along either of these paths. By applying a pulsed signal to the electrically actuated valve, the effective hydraulic resistance for the corresponding pilot tube path is increased or decreased by the duty cycle ratio. These hydraulic resistances determine the position of the diaphragm. The position of the diaphragm then determines the flow rate through the control valve. Thus, the flow rate of the irrigation valve is controlled by the duty cycle ratio of the signal applied to the electrically actuated valve.

In summary, our electronic valve control system is a spring diaphragm irrigation control valve where the flow rate is controlled with pulsed signal. This device functions as hydraulic amplifier where the input signal is characterized by the duty cycle ratio of the applied electrically signal, and the output is the flow rate through the irrigation valve.

It is envisioned that our electronic valve control system will include the following applications including but not limited to:

First, it can be used without feedback to open and close irrigation valves sufficiently slowly as to avoid water hammering and cavitation.

Second, when the supply side pressure is known and the hydraulic load is also known, the flow rate for the valve can be controlled without feedback.

Third, when the supply side pressure is not constant and/or known and the hydraulic load is not constant and/or known, feedback control is used to produce a stable regulated pressure. This requires a pressure measurement feedback so that the irrigation valve is controlled by a servo loop.

The description of these applications is intended only to provide practical examples of how our invention can be used. A person skilled in the art of irrigation may realize other uses of our application as well. Moreover, the descriptions of the various embodiments of our invention serve only to illustrate the best modes of operation. A person skilled in the art of irrigation valve design may also realize other specific designs that are operationally equivalent to the preferred embodiments described in this application/patent.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a cross section of a typical prior art irrigation control valve.

FIG. 2 shows a timing clock on a microprocessor to generate a valve control.

FIG. 3 shows a typical performance of the irrigation valve.

FIG. 4 shows an improved performance of the irrigation valve from a second preferred embodiment

FIG. 5 shows a cross section of an irrigation control valve with a secondary control port and a secondary ON/Off valve.

### DETAILED DESCRIPTION OF THE INVENTION

One of the key innovations of the electronic valve control system is a method to control the flow rate through a spring diaphragm control valve with a pulsed signal to an electrically actuated valve along the pilot tube path. The flow rate through the irrigation valve is controlled by varying the duty cycle of the pulsed signal.

A spring diaphragm irrigation control valve is used to control the flow of water. In general the spring diaphragm irrigation control valve can control the flow of any fluid. For this reason, the description of our invention will use the general term fluid.

Brief Description of Irrigation Valve

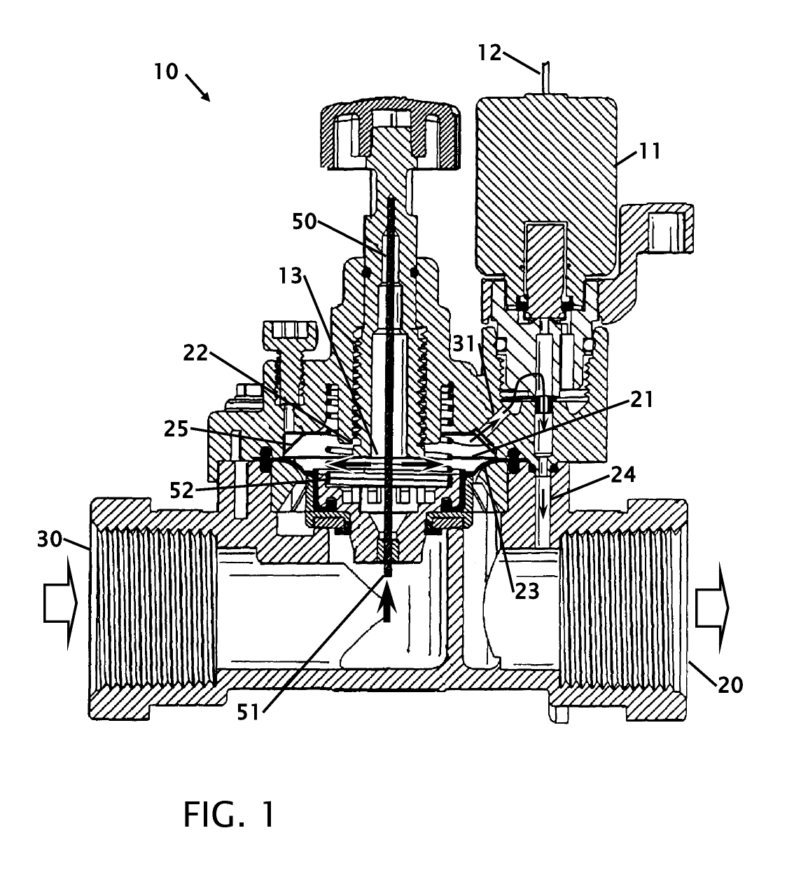

Since the electronic valve control system is a modification of a conventional spring diaphragm irrigation control valve, we provide a brief description of it and how it operates. Refer to FIG. 1 that shows a cross-section of a typical prior art irrigation control valve.

The flow through the irrigation valve 10 is controlled by the position of a diaphragm 21. When the diaphragm 21 is the open position, fluid flows through the irrigation valve, and when the diaphragm 21 is closed, no fluid flows.

The fluid enters through the supply side port 30 and exits through the load side port 20.

There is gap between the weir 23 and the diaphragm 21. A spring 22 presses the diaphragm 21 against the top of the weir 23. The control chamber is on the opposite side of the diaphragm 21 from the supply and load ports. The supply side pilot path 51 provides a flow path from the supply side port 30 to the control chamber 25. The load side pilot paths 31 and 24 provide a flow path from the control chamber 25 to the load side 20. Between the load side pilot paths 31 and 24 an electronically actuated valve is installed.

When the electronically actuated valve is closed, the load side pilot paths 31 and 24 are closed. The flow through supply side pilot path 51 causes the pressures in the control Chamber 25 and supply side port 20 to equalize. Since there is no Pressure differential across the diaphragm 21, the spring 22 pressures diaphragm 21 stopper (not shown but located below the diaphragm) firmly against the top of the weir 23 creating a seal. This seal prevents the flow of fluid from the supply port 30 to load port 20. In this state, the irrigation control valve 10 is closed.

When the electrically actuated valve is open, the load side pilot paths 31 and 24 are open. Fluid flows through both the supply side pilot path 51 which is smaller and the load side pilot paths 31 and 24. This produces a pressure drop across the pilot paths. The pressure in the control chamber 25 will drop until the flow rates in pilot path 51 is the same as it is in 31 and 24. This pressure drop creates a pressure differential across the two sides of the diaphragm 21. This pressure differential creates a force that works against the spring 22. The force due to the pressure differential is greater than the spring 22 force. This causes the diaphragm 21 to open, thereby creating a gap between the diaphragm 21 and the top of the weir 23. Now fluid flows through this gap. In this state, the irrigation valve is opened.

In the irrigation industry, the electrically actuated pilot valve for a spring diaphragm irrigation control values is a solenoid 11. It controls the opening and closing of the irrigation valve 10. Master control valves often used a normally open solenoid 11. A normally open solenoid will close when an electrical signal 12 is applied. The lateral line control valves use a normally closed solenoid 11. A normally closed solenoid 11 will open when an electrical signal 12 is applied. In either case, an electrical 12 signal turns the solenoid 11 on and off.

A solenoid valve 11 is the most obvious choice of an electrically actuated valve to use in a spring diaphragm irrigation valve 10. However, let us emphasize that this invention can use any type of electrically actuated valve. The requirement is that the electrically actuated valve is turned on and off with an electrical signal. Any electrically actuated valve that is functionally equivalent to a solenoid valve 11 may be used. The electrically actuated valve can be normally closed or normally open.

Duty Cycle

All the embodiments of this electronically actuated valve make use of an electrically actuated valve that is pulsed with an electrical signal. We define the duty cycle as the fraction of time the valve is open. This same definition is used for both normally closed and normally open electrically actuated valves. For a normally closed valve, the defined duty cycle is essentially the same as the duty cycle of the pulsed signal. For a normally open valve, the defined duty cycle is the same as the duty cycle of the inverted signal.

In the descriptions of the various embodiments, it is understood that either type of electrically actuated valve may be used. The operation of the electronically actuated valve using either type will be the same. The important parameter is the fraction of time the electrically actuated valve is open. We term this parameter duty cycle.

Control Accuracy

The accuracy of the duty cycle control is essential to the implementation of the pulsation method. The duty cycle of the electrical signal to the electrically actuated valve can be controlled very accurately with electronic circuits, especially digital circuitry.

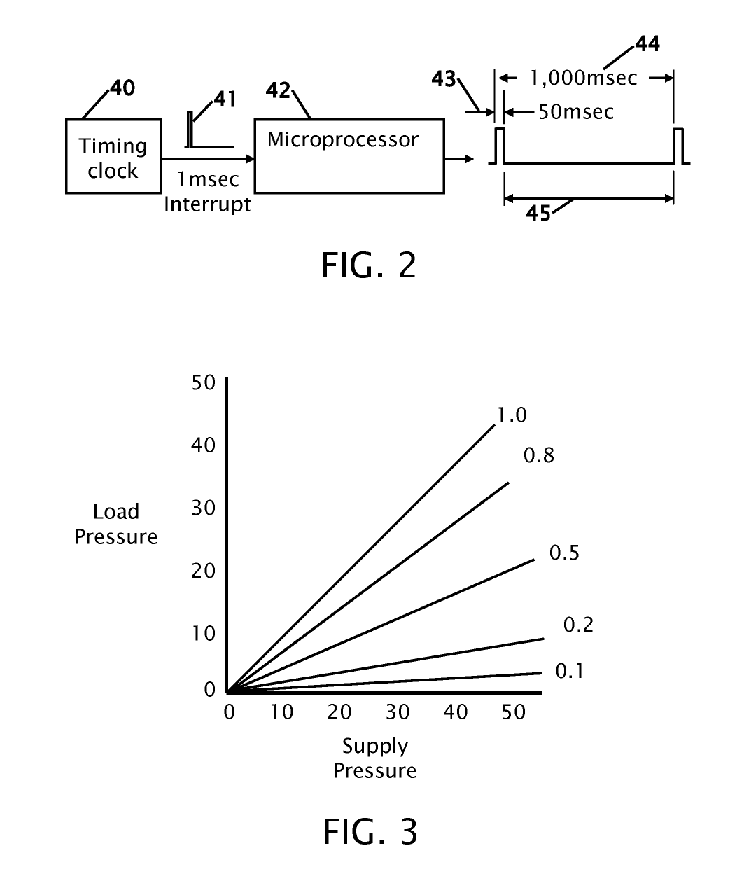

The duty cycle of a signal is the ratio of the time duration of a pulse to the time between pulses. Time can be measured accurately by many different methods. Any method that precisely controls the pulse width duration and time delay between pulses can be used to control the duty cycle of the applied signal. Thus, the duty cycle of the electrical control valve can be very precisely controlled using any suitable electronic method. The best method is to use a microprocessor as shown in FIG. 2. A timing clock 40 can interrupt the microprocessor 42 at regular intervals and the pulse duration and time between pulses can then controlled by counting the interrupts 41. For example, producing a pulse train with a 50 msec pulse width 43 and a 1 Hertz pulse frequency 44 could be implemented using 1 msec interrupt rate 41. In this example, the pulse train is produced by turning the electrical actuated valve on for 50 interrupts and off for 950 interrupts.

First Preferred Embodiment of Electronic Valve Control System

In the first preferred embodiment of the electronic valve control system, the system can be used with a conventional irrigation valve 10 with just one modification where the solenoid 11 of the electronically actuated valve 10 is rapidly pulsed. The load side pilot paths 31 and 24 flow will alternate on and off. Each pulse 43 of water will remove a small volume of water from the control chamber 25. This will cause a small displacement of the diaphragm 21. In between pulses 45, the diaphragm 21 will balance in the pressure differential between the chambers. This causes the diaphragm 21 to vibrate with the same frequency as the pulse frequency 43. For a sufficiently rapid pulse frequency 43, the movement of the diaphragm 21 will be small. The diaphragm 21 will vibrate or move around an average position. This average position is determined by the duty cycle or on 43 to off 45 ratio that is applied to the solenoid 11 of the electrically actuate valve 10.

In an irrigation system the hydraulic load is determined by the network of pipes and sprinklers. We will now define a hydraulic load factor. The fluid that flows into the load for a given pressure at the load side valve 20 is directly proportional to the hydraulic load factor. A typical hydraulic load is defined to have a hydraulic load factor of unity. With this definition, the hydraulic load factor is a relative measurement of hydraulic load. Heavy loads have a hydraulic load greater than one, and light loads have a hydraulic load less than one.

The typical performance of the irrigation valve for the first embodiment is shown in FIG. 3. The ratio between the load pressure on the ordinate and supply pressures in the abscissa is plotted as function of duty cycle for a number of different hydraulic loads. The hydraulic load factor for each curve is indicated by a number placed next to it. As illustrated in FIG. 3, the load side pressure is controlled by the duty cycle. For hydraulic load factors between zero and one, the load side pressure is controllable over the entire pressure range. For a duty cycle of zero, the irrigation valve is closed. For a duty cycle of one, the irrigation valve is fully open. For a duty cycle between 0 and 1, the irrigation valve is partially open. By varying the duty cycle, the irrigation valve flow can be adjusted.

A valve stop determines the maximum displacement of the diaphragm. In an irrigation valve, the position of the valve stop is adjusted manually, usually by turning a screw. For the electronic valve control system, the valve stop is adjusted so that the diaphragm 21 can move freely without buckling or inverting. The diaphragm 21 in most irrigation valves will buckle when then diaphragm 21 is displaced passed some distance. When irrigation valve 10 is operated either fully opened or closed, this buckling is not important. To control the irrigation valve 10 with the pulsation method, this bucking must be prevented. This can be achieved either by restricting the diaphragm 10 displacement using the valve stop 13 to eliminate bucking, or by using diaphragm 10 that does not buckle.

The hydraulic resistance depends on the geometry of the path. For example, for a tubular path the hydraulic resistance is proportional to the length and a function of its diameter. Thus, the hydraulic resistance is adjusted by changing the length of the tube and/or its diameter. For complex geometries, the adjustment of the hydraulic resistance follows the same principle.

The adjustment of hydraulic resistance of the load side pilot 31 and 24 paths is necessary so that the full range of duty cycles can be used. Without this adjustment, a duty cycle less than one may fully open the valve. The hydraulic resistance is adjusted so that a duty cycle of unity will not move the diaphragm past the valve stop position. In practice, this is done by gradually increasing the hydraulic resistance until the diaphragm 21 does not hit the valve stop 13. By changing the ratio between the supply side pilot path 51 and the load side paths 31 and 24, one can slow-up the movement of the diaphragm, thereby making it easier to control smoothly.

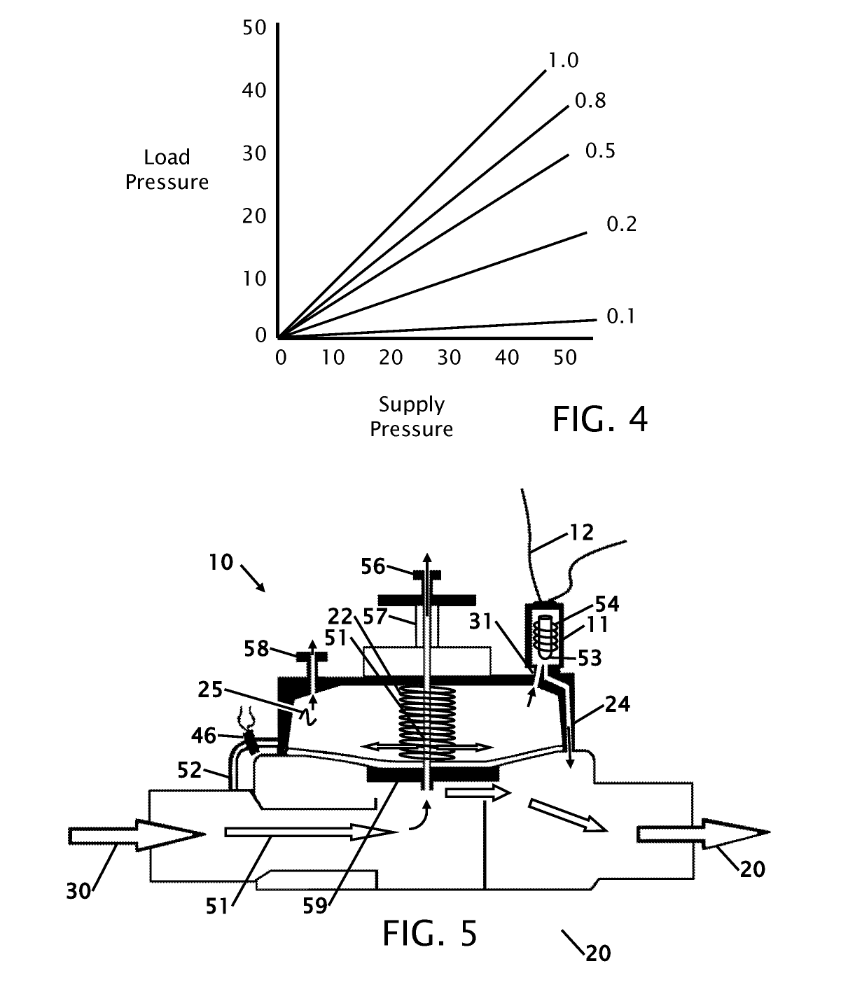

The typical performance of the second embodiment of the invention is shown in FIG. 4. Notice that a minimum duty cycle is required to begin turning the irrigation valve on. The control chamber 25 pressure decreases causing the load side 20 pressure to gradually increase as the duty cycle is increased. As shown in this figure, the duty cycle can control the load pressure over the full pressure range for both heavy and light hydraulic loads.

Second Preferred Embodiment of the Electronic Valve Control System

The second preferred embodiment of the invention shown in FIG. 5 is a modification of the first embodiment as shown in FIG. 1. The pilot tube paths are modified. The supply side pilot path 51 is significantly reduced in diameter. The load Side pilot path 24 and 31 are also reduced in diameter. The supply side is now connected by an outside tube 52 to the control chamber. This tube is dissected by a supply side pilot path control valve 46. When no control voltage is applied the only port opened is the supply side pilot path 51. This maintains the valve in a closed position. When constant control voltage is applied to both supply side pilot path control valve 46, and the load side solenoid valve 11 both are in the opened position. This will maintain a positive control chamber 25 pressure and result in zero flow through the spring diaphragm irrigation valve 10. When the supply side pilot control valve 46 is pulsed, and the solenoid valve 11 remains in a constant open position the pressure will decrease in the control chamber allowing the spring diaphragm valve to open, and the flow to be controlled by the duty cycle. This can be achieved by more than one method. One preferred method is to use an existing standard latching solenoid 11 that will stay opened as long as a small constant current is maintained. This will allow the non-latching supply side pilot control valve to be pulsed with a stronger signal. Another way to achieve this is to install a simple capacitor circuit at the valve that would keep the solenoid valve 11 from closing during the off cycle periods. Someone knowledgeable in irrigation valve function and design can likely devise other methods of achieving this as well.

As the supply side electrically actuated valve 46 is gradually opened by increasing its duty cycle. It should be noted that the relationship between the load pressure and the duty cycle is almost linear over the entire pressure range for both light and heavy loads. This is best achieved by pulsing a supply side port or tube and having proper supply and load port tube diameter ratios.

For this embodiment two different electrical signals are provided to the irrigation control valve. One signal operates the load side solenoid valve creating an opened state. The other signal pulses the supply side ON/OFF valve 46 located along the external pilot tube 52 controlling the pressure and flow of the irrigation control valve 10. Putting the or solenoid valve 11 in an on state opens the valve, then the pulsing the supply side electrically actuated external On/Off valve 46 closes the valve by an amount determines by its duty cycle.

The hydraulic resistance for the diaphragm chamber pilot path 26 is adjusted so that when the supply side electrically actuated valve 11 pulsed with a 100% duty cycle, i.e., full open, the irrigation control valve 10 is completely closed. When the supply side exterior pilot tube and the load side pilot tubes are fully actuated the valve is closed.

Bleed screw 56, located at the end of the valve stem 55, can be opened to allow flow through the supply port 51 to open the valve. Hand bleed valve 58 shows a common alternate location for a bleed valve that does the same thing. At either location a bleed valve can be opened to allow relief of hydraulic pressure on top of the diaphragm 21 within the control chamber 25. The flow control handle at the top of the valve stem 57 can be used to manually regulate how far the diaphragm 21 can open thereby controlling the flow from the supply side 30 to the load side 20.

Adjustment of Pilot Path Hydraulic Resistance

The hydraulic resistances are best adjusted by testing. For example, if a pilot path is a tube, the length and/or diameter of the tube is varied until the required operation of the valve is achieved.

Pulsation of Electrically Actuated Valve

The electrically actuated valve has two states, opened or closed. A normally closed valve will open when a signal is applied. The fraction of time the valve is open is equal to the duty cycle of the pulse signal. A normally open valve will close when a signal is applied. The fraction of time the valve is open is equal to the duty cycle of the inverted pulsed signal. Either type of valve can be used. In either case, we will refer to the fraction of time that the valve is open as the duty cycle in the electronically actuated valves that control the pilot tubes

One key operation principle is that the pulsing of the signal to the electronically actuated valve controls the average flow rate through the pilot paths of the irrigation valve. The average flow rate is proportional to the fraction of time that electrically actuated valve is open. We will refer to this fraction as the duty cycle. It should be noted that this definition applies to both normally open and normally closed electronically actuated valves. The use of these two kinds of valves is the same except that signal for normally open valve is inverted compared the signal for a normally close valve.

The pulsing of the electrically actuated valve produces a pulse flow through it. If each pulse passes only a very small amount of water through the valve, then the average effect of the pulses produces a flow equivalent to a steady state flow with reduce flow rate. The average flow rate is proportional to the duty cycle.

The solenoid ON/OFF valve 46 is turned on by applying an electrical signal 12. A pulsed electrical signal will produce a pulsed flow within the small tube. The ratio of the pulse width 43 to the time between pulses 45 (from FIG. 2) is the duty cycle. The average pulsed flow rate is nearly proportional to the duty cycle of the signal applied. The duty cycle ratio is varied by changing either or both the pulse width 43 and time between pulses 45. This later quantity is equivalently defined by the pulse frequency 41.

Preferred Choices for Electrically Actuated Valve

The electronic valve control system can use any type of electrically actuated valve. A good choice is a solenoid 11. The solenoid 11 can be either a direct current (DC) or alternating current (DC) type, however, the operational use is different. For this reason, we describe these two different cases separately.

Pulsed DC Solenoid

A DC solenoid 11 is turned on by applying a DC electrical 12 signal to the solenoid 11. There is a time delay between the application of the DC signal and response of the solenoid. The full flow rate is not achieved until the solenoid 11 is completely open. Likewise, it takes some time for the solenoid 11 to shut when the DC signal is removed. The flow then continues for a short while. The deficiency of flow during the opening of the solenoid 11 is approximately balanced by the excess of flow during the closing the solenoid 11. The result is that that total amount of water that passes through the small tube 31 during the pulse is proportional to the duty cycle with only a small offset.

The pulse width must be longer than the time required for the solenoid 11 to turn on. This time delay is the minimum time interval that may be used for the pulse width.

This electronic valve control system can use a solenoid 11 that either normally on or off. In the following description, a normally closed solenoid 11 is described. The use of a normally opened solenoid 11 is the same except that the electrical signal is inverted.

Pulsed AC Solenoid

An AC solenoid is turned on by applying an AC electrical 12 signal. This type of solenoid 11 has a primary and secondary coil. The electrical 12 signal is applied to the primary coil. Magnetic induction produces current in the secondary coil. The secondary coil is always 90 degrees out of phase. Like the DC solenoid, it will take time for the AC solenoid to respond. The solenoid will be fully open when the applied signal has its maximum magnitude. During the crossover of the applied signal, the solenoid 11 is kept open by the current in the secondary coil; however, the solenoid may not be completely opened. This causes a small oscillation of the flow rate. Physically, this oscillation is caused because the secondary coil has less strength to open the solenoid than the primary coil. Typically secondary coils only hold a valve but do not open the flow valve.

The pulsed AC signal is most easily produced by placing an electronic switch in between a continuous AC signal and the solenoid 11. A mechanical relay switch will be too slow. Instead, a fast electrical switch such as a MOSFET transistor should be used.

To maintain proportionality with the duty cycle ration, the pulse to the electronic switch is synchronized with the AC signal. The pulse raise and fall should be at crossover points of the AC signal. This requires that the pulse width be an integer multiple of one half the period of the AC signal.

Like the DC solenoid, there is a time delay for the solenoid to achieve a fully opened state. The minimum pulse width is the smallest half multiple of the AC signal period that is greater the time required to turn on the solenoid.

Applications of the Electronic Valve Control System

Since this application/patent provides a means to control the flow rate of an irrigation valve electronically, the irrigation system control can vary the flow rate in real time. The real time control has a number of usefully applications that we now describe.

First Application

Water hammering and cavitation are caused by opening and closing the irrigation valve to quickly. This problem can be avoided by using this invention. As the duty cycle is gradually increased, the irrigation valve gradually opened. The duty cycle slew rate can be controlled by the irrigation system controller. By making the duty cycle slew rate sufficiently slow, the irrigation valve can always be opened slowly enough to avoid water hammering and cavitation. The duty cycle gradually increases from zero to unit, thereby slowly opening the irrigation valve to its fully open position. The duty cycle rate can be individually adjusted for each irrigation valve. Because the hydraulic conditions throughout an irrigation system vary, necessary duty cycle slew rate for each irrigation control valve will be different. For efficient time management of the irrigation system, the open and close rates should not be longer than necessary. This disclosure provides a simple means of opening and closing each individual irrigation control valve at the rate necessary to avoid water hammering and cavitation.

Second Application

In addition to controlling the open and close rate of the irrigation valve, this invention can be used to partially open the irrigation control valve. For conventional irrigation control valves, the pressure at the valve is adjusted manually. With the electronic valve control system, this is done using electrical control instead. The duty cycle is adjusted by the irrigation system controller to produce the required flow rate or pressure at the irrigation valve. This application assumes that the hydraulic load does not change. This assumption is valid for the lateral line irrigation control valves. Once an irrigation system is installed, the hydraulic load does not change unless changes are made to irrigation on the load side of the lateral line irrigation valve. If a change is made, then the duty cycle required for the new load must be determined again.

Third Application

By installing an electrical pressure transducer on the load side of the valve and returning this signal to the irrigation system controller, the value can be operated with feedback control. The feedback permits the valve to have its pressure regulated by the irrigation system controller. This application is particularly suitable to the master irrigation valve. The load side master valve pressure can be regulated to a set valve. Moreover, it can be varied so that each lateral line control valve provides the required operation pressure.

Utility of the Electronic Valve Control System

This electronic valve control system moves the control of the irrigation control valve from the valve to the irrigation system controller. The control is now electrical rather than manual. Moreover, the electrical control may be produced by an irrigation system control that is run by a microprocessor. A microprocessor can be programmed to make sophisticated decisions. This provides a powerful and flexible new method of operating irrigation systems. The microcontroller can be embedded into the valve and can be programmable or adjustable.

A person skilled in the art of irrigation could realize other applications of this electronic valve control system. The description of the potential applications serves to provide indication of how this electronic valve control system many be used. The advantage of this invention is that duty cycle of the irrigation control valve can be electrically controlled. This electrical control provides an electronic controller a means to fully control each irrigation control valve within the irrigation system. The flow rate and resulting pressure at each irrigation control valve can be controlled. The open and close rate of each irrigation valve can be also controlled. In general, replacing manual control with electrical control opens up a whole new field of potential applications.

Retrofitting verse Customer Design

The specific embodiments of the electronic valve control system can be implemented by either retrofitting a conventional irrigation valve or by making a custom irrigation valve. The end result is the same for either retrofitting or custom design. The two approaches are just different manufacturing methods of producing the same device.

The retrofit approach has the advantage that an existing valve can be adapted using a retrofit kit. Also, commercially available irrigation valves can be custom retrofitted in a manufacturing facility.

Other Implementations

A person skilled in the art of irrigation valve design could realize other somewhat different specific methods of implementation other that the preferred embodiments we have described. A key innovation that any implementation would use is the pulsing of the electrical actuated valve to provide a precise means of controlling the flow through the pilot paths, thereby controlling the flow and pressure at the irrigation valve. There are numerous ways of constructing the pilot paths that would be functionally equivalent. The electrically actuated valve can be placed many different positions along the pilot paths that are functionally equivalent.

The innovation of the electronic valve control system is a pulsation method of controlling an irrigation control valve. We described two different preferred embodiments, but many other specific designs based on the principles are possible.

Thus, specific embodiments of an electronic valve control system have been disclosed. It should be apparent, however, to those skilled in the art that many more modifications besides those described are possible without departing from the inventive concepts herein. The inventive subject matter, therefore, is not to be restricted except in the spirit of the appended claims.

1. An electronic valve control system comprising:
a control circuit that is connectable to a solenoid controlled valve having a diaphragm;
said control circuit having a modulated control over said solenoid;
said modulated control provides a variable duty cycle to said solenoid to adjust a differential between a supply pressure and a load pressure.

2. The electronic valve control system according to claim 1 wherein said solenoid controlled valve has at least one supply side pilot port that connects from a supply port.

3. The electronic valve control system according to claim 2 wherein flow through said at least one supply side pilot port is controlled by said solenoid.

4. The electronic valve control system according to claim 3 wherein when said solenoid is operated said flow will travel through said at least one supply side pilot port into a control chamber and out through a load side pilot port.

5. The electronic valve control system according to claim 4 wherein said control chamber operates said diaphragm.

6. The electronic valve control system according to claim 5 wherein said diaphragm is restrained by a spring.

7. The electronic valve control system according to claim 5 wherein said control system maintains said diaphragm in a condition between completely open and completely closed.

8. The electronic valve control system according to claim 4 wherein said load side port connects to a load port.

9. The electronic valve control system according to claim 4 wherein said load side port vents to atmosphere.

10. The electronic valve control system according to claim 4 wherein said at least one supply side pilot port connects to a separate on and off valve.

11. The electronic valve control system according to claim 10 wherein said separate on and off valve connects to said load side port.

12. The electronic valve control system according to claim 4 further includes a pressure measurement feedback.

13. The electronic valve control system according to claim 12 wherein said pressure measurement feedback creates a servo loop.

14. The electronic valve control system according to claim 4 wherein said variable duty cycle is gradually increased from zero to slowly adjust said differential between said supply pressure and said load pressure.

15. The electronic valve control system according to claim 4 wherein said solenoid controlled valve is an irrigation valve.

16. The electronic valve control system according to claim 4 wherein said solenoid controlled valve is a master irrigation valve.

17. The electronic valve control system according to claim 16 wherein said master irrigation valve supplies a plurality of separate valves.

18. The electronic valve control system according to claim 17 wherein said duty cycle is adjustable for each said separate valves.

19. The electronic valve control system according to claim 4 wherein said solenoid is a pulsed AC or static AC solenoid.

20. The electronic valve control system according to claim 4 wherein said solenoid is a DC solenoid.
